(19) United States
(12) Patent Application Publication
(10) Pub. No.: US 2015/0108049 A1
(43) Pub. Date: Apr. 23, 2015

(54) WATER-FILTRATION DETECTING DEVICE OF WATER FILTER

(71) Applicant: I-SIN PENG, Taichung (TW)

(72) Inventor: I-SIN PENG, Taichung (TW)

(21) Appl. No.: 14/057,062

(22) Filed: Oct. 18, 2013

(51) Int. Cl. B01D 35/143

(52) U.S. Cl. CPC B01D 35/1435
USPC 210/85

(57) ABSTRACT

A water-filtration detecting device of a water filter includes a connecting member disposed at the bottom of an accommodation casing of the water filter. The connecting member has first and second detecting terminals, first and second outer threaded portions, and a protruding ring. A waterproof wire connector has a connector and a wire. The connector has two wire terminals passing through the second outer threaded portion and electrically connected with the first and second detecting terminals, respectively. One end of the wire is electrically connected with the connector. A warning device is electrically connected to another end of the wire of the waterproof wire connector. When water in the accommodation casing is contact with both the first and second detecting terminals, the first and second detecting terminals are conducted to conduct the waterproof wire connector for the warning device to generate a warning signal.

### BACKGROUND OF THE INVENTION

1. Field of the Invention

The present invention relates to a water filter, and more particularly to a water-filtration detecting device of a water filter.

2. Description of the Prior Art

In general, the water separated by an oil-water separator is stored in an accommodation casing. After a period of time (such as life time) or according to the experience of the operator, it is required to discharge the water or replace the water filter.

However, this way may influence the efficiency of the water filter or cause a waste when the liquid has not reached the predetermined value.

Therefore, Parker/Racor Company developed a water filter (Model No. Marine Turbine Series 500MA). A bowl-shaped structure is provided under the water filter. A water probe assembly is provided in the bowl-shaped structure. The bowl-shaped structure is installed under an accommodation casing of the water filter to probe the water capacity inside the accommodation casing.

The bowl-shaped structure must be coupled to the bottom of the accommodation casing of the water filter, so the size of the water filter becomes large. This water filter doesn't have a warning effect when the liquid reaches the predetermined value

Accordingly, the inventor of the present invention has devoted himself based on his many years of practical experiences to solve this problem.

### SUMMARY OF THE INVENTION

The primary object of the present invention is to provide a water-filtration detecting device of a water filter. The water-filtration detecting device is mounted at the bottom of the water filter. A first detecting terminal and a second water-filtration detecting device are conducted when the liquid reaches a certain level. A water waterproof wire connector is to activate a warning device which is located out of the water filter. It is convenient for the operator to know the liquid inside the accommodation casing reaches the predetermined capacity so as to discharge the water or replace the water filter. The water-filtration detecting device of the present invention has a simple structure and is convenient for operation and assembly.

In order to achieve the aforesaid object, the water-filtration detecting device of the present invention is used for a water filter. The water filter has at least an accommodation casing. The water-filtration detecting device comprises a connecting member, a waterproof wire connector, and a warning device. The connecting member is disposed at the bottom of the accommodation casing. The connecting member has a first detecting terminal, a second detecting terminal, a first outer threaded portion, a protruding ring, and a second outer threaded portion. One end of the outer threaded portion is connected with both the first detecting terminal and the second detecting terminal. The first detecting terminal and the second detecting terminal are located inside the accommodation casing. The first outer threaded portion is removably screwed to the accommodation casing. Another end of the first outer threaded portion, opposite to the first detecting terminal and the second detecting terminal, are connected to the protruding ring. The protruding ring is located outside the accommodation casing. The second threaded portion is disposed at one end of the protruding ring, opposite to the first threaded portion. The waterproof wire connector has a connector and a wire. The connector has two wire terminals. The two wire terminals pass through the second outer threaded portion and are electrically connected with the first detecting terminal and the second detecting terminal, respectively. One end of the wire is electrically connected with the connector. The warning device is electrically connected to another end of the wire of the waterproof wire connector, opposite to the connector. Wherein, when water inside the accommodation casing is contact with both the first detecting terminal and the second detecting terminal, the first detecting terminal and the second detecting terminal are conducted to conduct the waterproof wire connector for the warning device to generate a warning signal.

In some embodiments, the first detecting terminal and the second detecting terminal have the same length or different lengths.

In one embodiment, the warning device is a sound warning device, and the warning signal is a warning sound.

In one embodiment, the warning device is an optical warning device, and the warning signal is a warning light.

In one embodiment, an O-shaped ring is fitted on the first outer threaded portion and located between the protruding ring and the bottom of the accommodation casing.

### BRIEF DESCRIPTION OF THE DRAWINGS

FIG. 1 is a perspective view showing the water-filtration detecting device of the present invention coupled to a water filter;

FIG. 2 is a partial exploded view showing the water-filtration detecting device of the present invention coupled to the water filter;

FIG. 3 is a sectional view showing the water-filtration detecting device of the present invention coupled to the water filter;

FIG. 4 is a perspective view showing the water-filtration detecting device of the present invention;

FIG. 5 is an exploded view showing the water-filtration detecting device of the present invention;

FIG. 6 is another perspective view showing the water-filtration detecting device of the present invention;

FIG. 7 is a perspective view showing the water-filtration detecting device of the present invention coupled to another water filter; and

FIG. 8 is a partial exploded view showing the water-filtration detecting device of the present invention coupled to the water filter.

### DETAILED DESCRIPTION OF THE PREFERRED EMBODIMENTS

Embodiments of the present invention will now be described, by way of example only, with reference to the accompanying drawings.

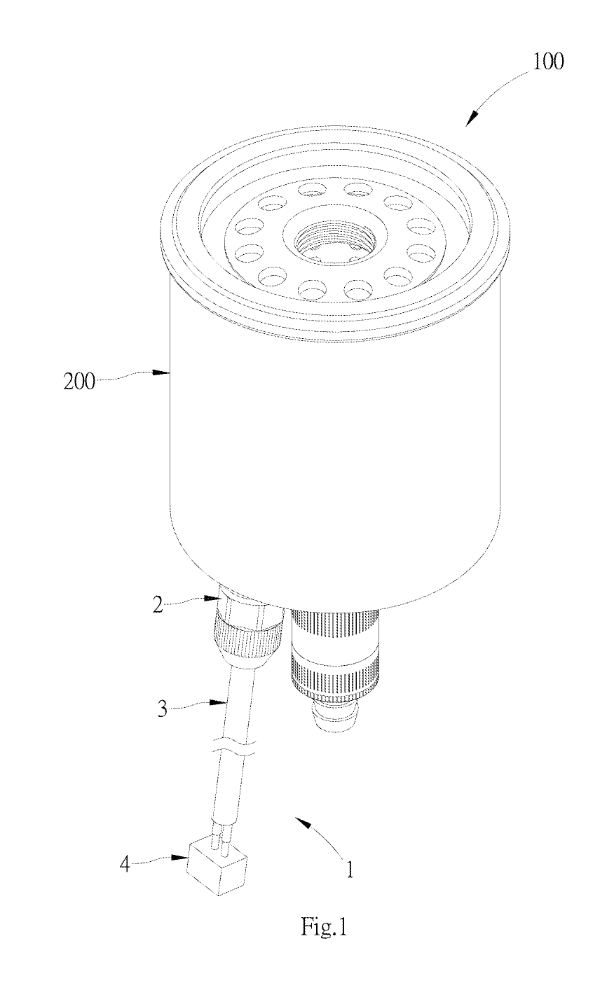

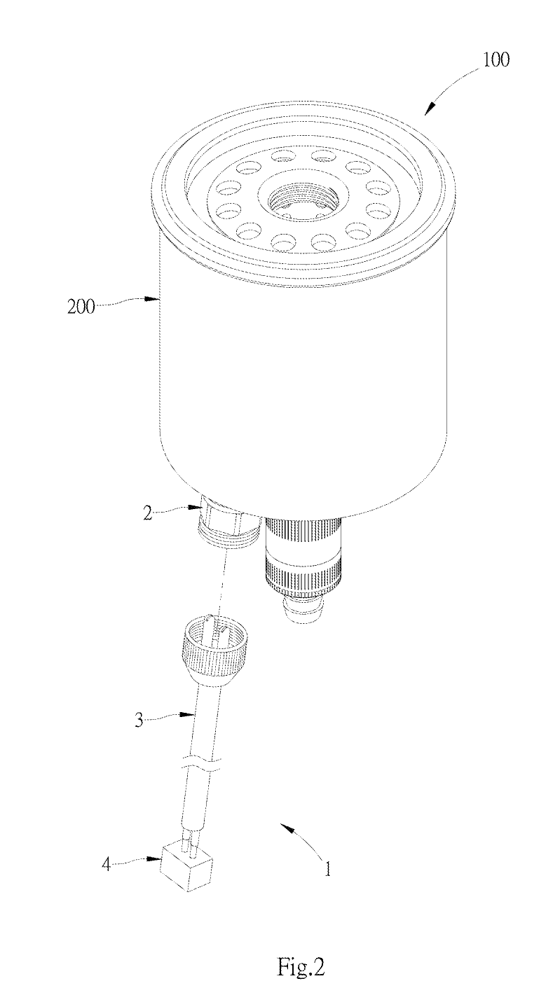

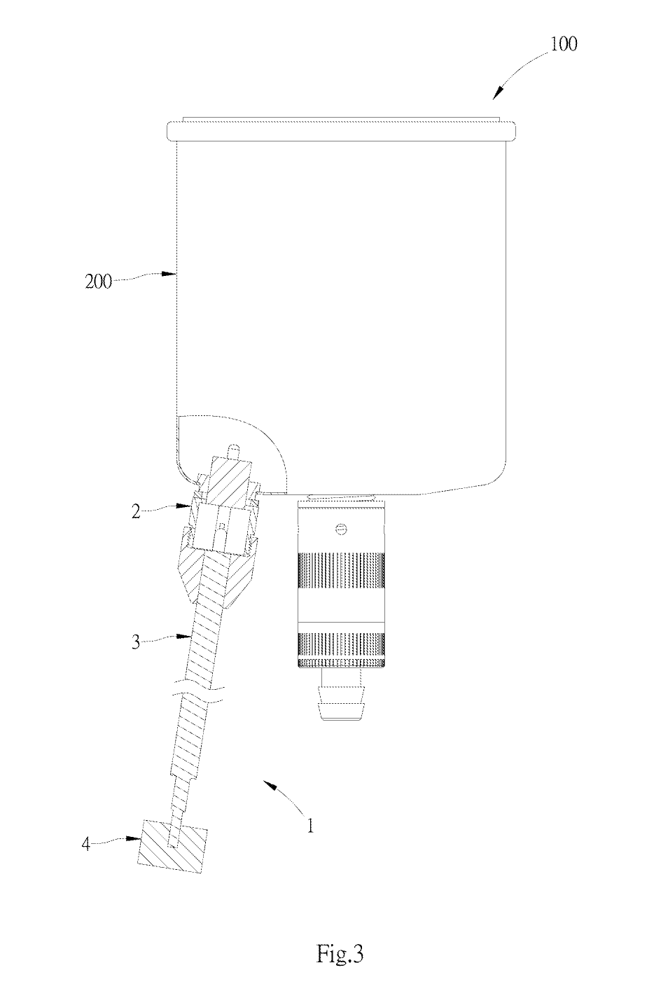

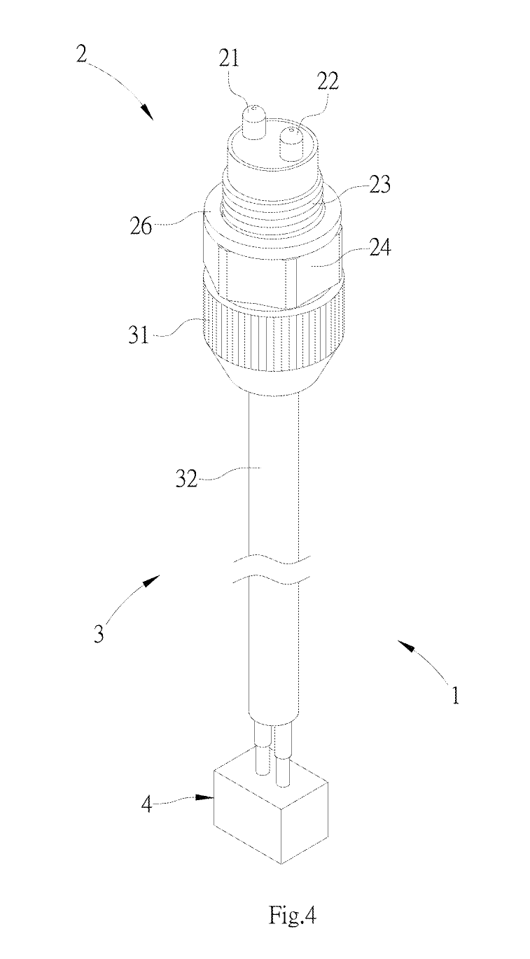

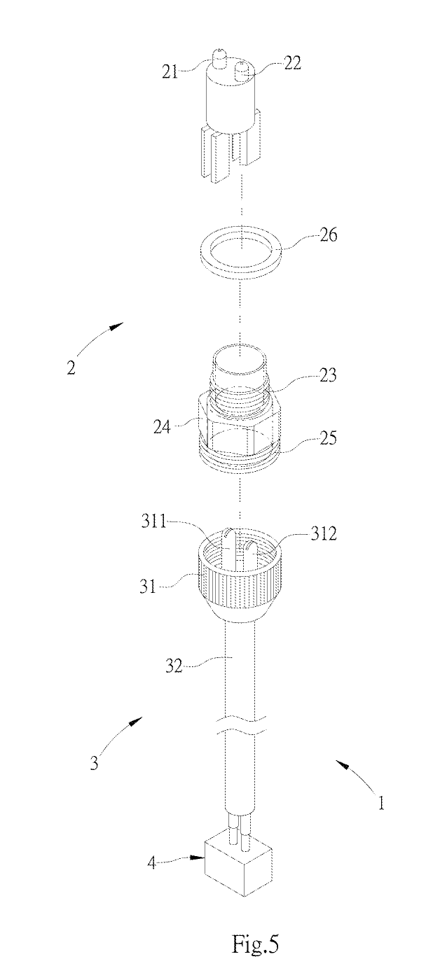

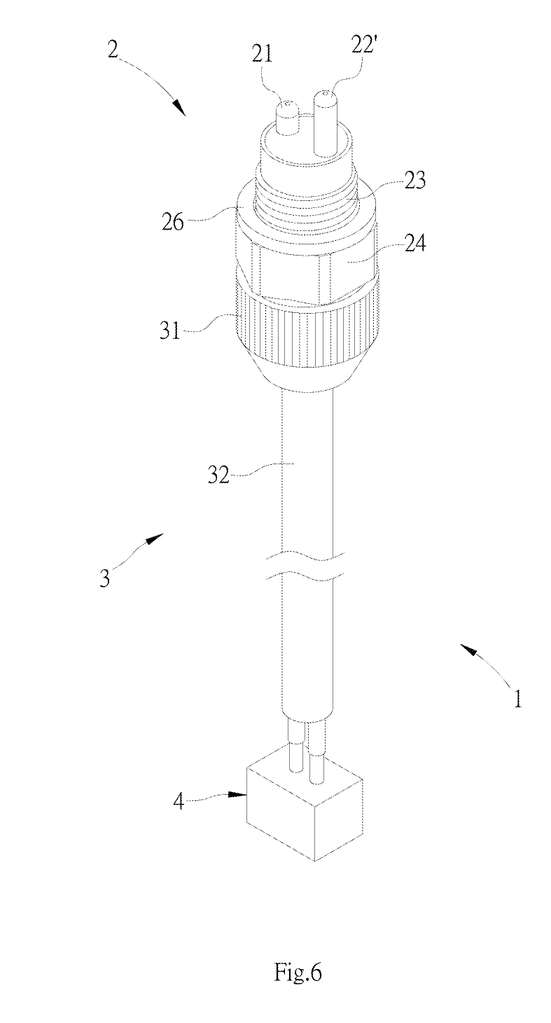

FIG. 1 is a perspective view showing the water-filtration detecting device of the present invention coupled to a water filter. FIG. 2 is a partial exploded view showing the water-filtration detecting device of the present invention coupled to the water filter. FIG. 3 is a sectional view showing the water-filtration detecting device of the present invention coupled to the water filter. FIG. 4 is a perspective view showing the water-filtration detecting device of the present invention. FIG. 5 is an exploded view showing the water-filtration detecting device of the present invention. FIG. 6 is another perspective view showing the water-filtration detecting device of the present invention;

Referring to FIG. 1 to FIG. 3, the water-filtration detecting device of the present invention is coupled to a water filter 100 which is an oil-water separator and integrally formed by casting, but no limited. The water filter 100 has at least an accommodation casing 200 to accommodate the separated water fluid.

Referring to FIG. 4 to FIG. 6, the water-filtration detecting device 1 of the present invention comprises a connecting member 2, a waterproof wire connector 3, and a warning device 4.

The connecting member 2 is disposed at the bottom of the accommodation casing 200. The connecting member 2 has a first detecting terminal 21, a second detecting terminal 22, a first outer threaded portion 23, a protruding ring 24, and a second outer threaded portion 25. One end of the outer threaded portion 23 is connected with both the first detecting terminal 21 and the second detecting terminal 22, and the first detecting terminal 21 and the second detecting terminal 22 are located inside the accommodation casing 200. The first outer threaded portion 23 is removably screwed to the accommodation casing 200. Another end of the first outer threaded portion 23, opposite to the first detecting terminal 21 and the second detecting terminal 22, is connected to the protruding ring 24. The protruding ring 24 is located outside the accommodation casing 200. The second threaded portion 25 is disposed at one end of the protruding ring 24, opposite to the first threaded portion 23. The protruding ring 24 is convenient for the user to apply a force to the first outer threaded portion 23 to connect with or disconnect from the accommodation casing 200.

Furthermore, the first detecting terminal 21 and the second detecting terminal 22 have the same length (as shown in FIG. 4) or different lengths (as shown in FIG. 6), which are designed according to the level of the liquid to be detected.

An O-shaped ring 26 is fitted on the first outer threaded portion 23 and located between the protruding ring 24 and the bottom of the accommodation casing 200, preventing the water from leaking.

The waterproof wire connector 3 has a connector 31 and a wire 32. The connector 31 has two wire terminals 311, 312. The two wire terminals 311, 312 pass through the second outer threaded portion 25 and are electrically connected with the first detecting terminal 21 and the second detecting terminal 22, respectively. One end of the wire 32 is electrically connected with the connector 31.

The warning device 4 is electrically connected to another end of the wire 32 of the waterproof wire connector 3, opposite to the connector 31. Wherein, the warning device 4 can be a sound warning device or an optical warning device. When the warning device 4 is a sound warning device (such as a buzzer), the warning signal is a warning sound. When the warning device 4 is a light warning device (such as an LED lamp), the warning signal is a warning light in the way to twinkle or shine.

When the water inside the accommodation casing 200 is contact with both the first detecting terminal 21 and the second detecting terminal 22, the first detecting terminal 21 and the second detecting terminal 22 are conducted to conduct the waterproof wire connector 3 for the warning device 4 to generate a warning signal, such as light or sound, so as to discharge the water or replace the water filter.

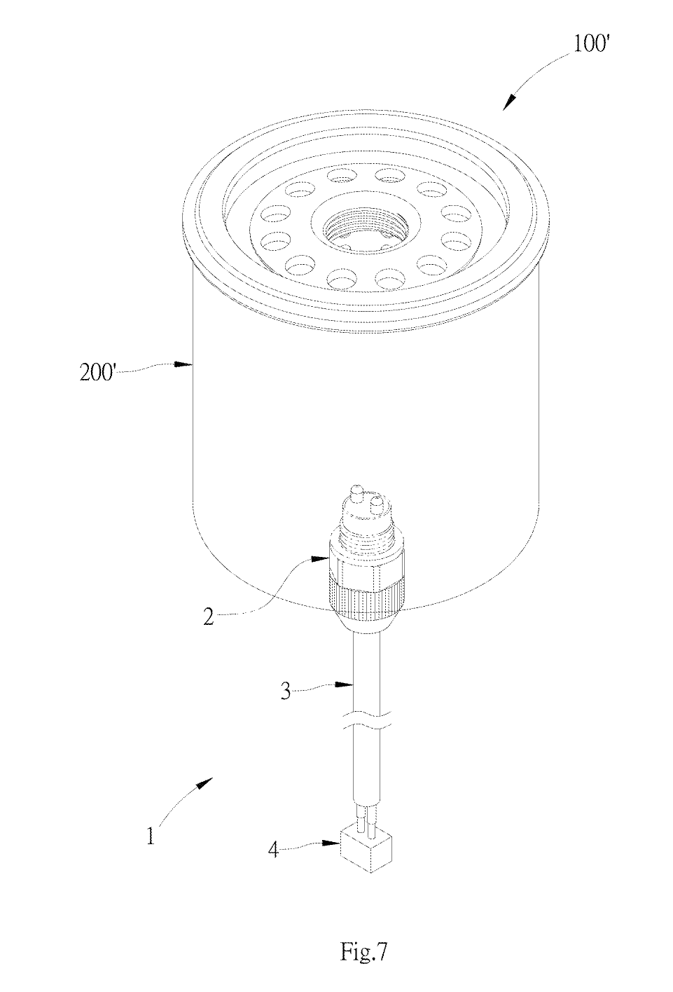

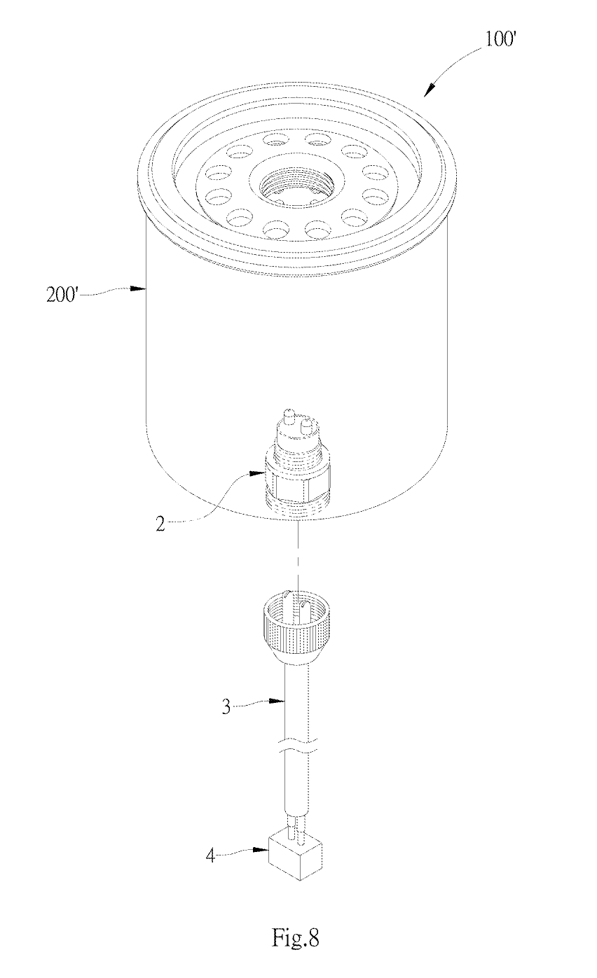

FIG. 7 is a perspective view showing the water-filtration detecting device of the present invention coupled to another water filter. FIG. 8 is a partial exploded view showing the water-filtration detecting device of the present invention coupled to the water filter.

Referring to FIG. 7 and FIG. 8, in this embodiment, a water filter 100′ also has an accommodation casing 200′ and is an oil-water separator mad of an iron plate. The water-filtration detecting device 1 of the present invention is also disposed at the bottom of the accommodation casing 200′ to provide the same effect as used in the water filter 100.

The water-filtration detecting device of the present invention has a simple structure and is convenient for operation and assembly. The water-filtration detecting device is able to detect the liquid capacity inside the water filter, without making a guess to discharge water or replace the water filter.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A water-filtration detecting device of a water filter, the water filter having at least an accommodation casing, the water-filtration detecting device comprising:
a connecting member, the connecting member being disposed at a bottom of the accommodation casing, the connecting member has a first detecting terminal, a second detecting terminal, a first outer threaded portion, a protruding ring and a second outer threaded portion, one end of the outer threaded portion being connected with both the first detecting terminal and the second detecting terminal, the first detecting terminal and the second detecting terminal being located inside the accommodation casing, the first outer threaded portion being removably screwed to the accommodation casing, another end of the first outer threaded portion, opposite to the first detecting terminal and the second detecting terminal, being connected to the protruding ring, the protruding ring being located outside the accommodation casing, the second threaded portion being disposed at one end of the protruding ring, opposite to the first threaded portion;
a waterproof wire connector, the waterproof wire connector having a connector and a wire, the connector having two wire terminals, the two wire terminals passing through the second outer threaded portion and being electrically connected with the first detecting terminal and the second detecting terminal respectively, one end of the wire being electrically connected with the connector; and
a warning device, the warning device being electrically connected to another end of the wire of the waterproof wire connector, opposite to the connector.;
wherein, when water inside the accommodation casing is contact with both the first detecting terminal and the second detecting terminal, the first detecting terminal and the second detecting terminal are conducted to conduct the waterproof wire connector for the warning device to generate a warning signal.

2. The water-filtration detecting device of a water filter as claimed in claim 1, wherein the first detecting terminal and the second detecting terminal have the same length.

3. The water-filtration detecting device of a water filter as claimed in claim 1, wherein the first detecting terminal and the second detecting terminal have different lengths.

4. The water-filtration detecting device of a water filter as claimed in claim 1, wherein the warning device is one of a sound warning device and an optical warning device.

5. The water-filtration detecting device of a water filter as claimed in claim 4, wherein the warning device is a sound warning device, and the warning signal is a warning sound.

6. The water-filtration detecting device of a water filter as claimed in claim 4, wherein the warning device is an optical warning device, and the warning signal is a warning light.

7. The water-filtration detecting device of a water filter as claimed in claim 1, wherein an O-shaped ring is fitted on the first outer threaded portion and located between the protruding ring and the bottom of the accommodation casing.
